(19) United States
(12) Patent Application Publication
(10) Pub. No.: US 2025/0266775 A1
(43) Pub. Date: Aug. 21, 2025

(54) TECHNIQUE TO ALTER A HIGH VOLTAGE FOR A LOWER VOLTAGE LOAD

(71) Applicant: Kerri Anne Sullivan, Portland, OR (US)

(72) Inventor: Kerri Anne Sullivan, Portland, OR (US)

(21) Appl. No.: 19/006,574

(22) Filed: Dec. 31, 2024

Related U.S. Application Data
(60) Provisional application No. 63/555,709, filed on Feb. 20, 2024.

(51) Int. Cl. H02M 7/46; H02H 7/125; H02M 1/14; H02M 7/00

(52) U.S. Cl. CPC H02M 7/46; H02H 7/1257; H02M 1/14; H02M 7/003

(57) ABSTRACT

The invention is a mechanism to alter a high voltage to a lower voltage load by connecting an electrical breaker to a variable frequency drive where the electrical load is connected to the electrical breaker. Additionally, the electrical breaker includes a means to prevent excessive current. The VFD can convert AC voltage to DC voltage, absorb and filter out high-frequency DC voltage variations, store the electricity, smooth the electricity out, convert electricity to a desired waveform, and output the electricity in the desired waveform.

### CROSS REFERENCE TO RELATED APPLICATIONS

This application claims priority to the co-pending U.S. Provisional Application Ser. No. 63/555,709, filed on Feb. 20, 2024, incorporated herein by reference for all purposes.

### BACKGROUND

The present disclosure relates to a system that includes an electrical breaker and a variable frequency drive (VFD) to safely allow for higher voltages (e.g., 208 V, 480/277 V) to be utilized for lower voltage loads (e.g., 120 V). The device clips into an electric panel just as an electrical breaker does; however, the system uses the VFD to control the output frequency and voltage. For instance, 208 V B phase high leg voltage may be controlled such that the output is 120 V. A 480/277 V service can be manipulated in the same manner.

The main parts of the system connect together within an electrical breaker. One side of the electrical breaker retains its original function as a circuit-breaking overcurrent protection device. The other side of the device functions as the VFD. A bus clip connects to the rectifier on the VFD side. An insulated wall separates the bus clip from the stationary contact on the device's overcurrent protection side. A jumper connects this stationary contact to the inverter on the opposing side of the

device. The inverter outputs the altered input voltage downstream from the rectifier and capacitor, rendering a suitable voltage for the new load demand/requirements. The system allows for the controlling and changing of the voltage for any desired load requirement. The system consolidates the VFD and the electrical breaker into one functioning device instead of requiring multiple devices. The system may be utilized within a three-pole breaker, a two-pole breaker, or a single-pole breaker. For example, a single pole device may clip into the 208 V B phase high leg space in an electric panel, permitting the use of a 120 v load without ruining the load.

The inverter connected to the stationary contact on the overcurrent protection side of the device allows for the altered voltage to reach the load via the terminal and terminal screw at the desired/required voltage denoted by any load.

### SUMMARY

The invention is a mechanism to alter a high voltage to a lower voltage load by connecting an electrical breaker to a variable frequency drive where the electrical load is connected to the electrical breaker. Additionally, the electrical breaker includes a means to prevent excessive current. The VFD can convert AC voltage to DC voltage, absorb and filter out high-frequency DC voltage variations, store the electricity, smooth the electricity out, convert electricity to a desired waveform, and output the electricity in the desired waveform. The invention can be used on 1, 2, 3, or 4 pole breakers.

### BRIEF DESCRIPTION OF THE DRAWINGS

FIG. 1 depicts the device's grove and clip as well as the terminal screw and wire terminal.

FIG. 2 depicts the electromagnet's busbar clip and inner mechanisms working in unison with the VFD.

FIG. 3 depicts the construction of the electromagnet mechanism, which protects the load.

FIG. 4 depicts the VFD construction and connection to the electromagnetic mechanism.

### DETAILED DESCRIPTION

The disclosed mechanism will become better understood through a review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

The following detailed description provides examples of various elements of the mechanism. Related features in the examples may be identical, similar, or dissimilar in different examples. For the sake of brevity, related features will not be redundantly explained in each example. Instead, using related feature names will cue the reader that the feature with a related name may be similar to the related feature in an example explained previously. Features specific to a given example will be described in that particular example. The reader should understand that a given feature need not be the same or similar to the specific portrayal of a related feature in any given figure or example.

The mechanism can be used in a variety of electric panels. The voltage regulation electrical breaker can alter the input voltage for any desired output voltage. The device can be utilized and installed in one, two, three, even four or more spaces within an electric panel. The device can be made to fill this space as a single-pole, two-pole, three-pole, or quad voltage regulating breaker. The most common uses would be as a single pole or three polled device taking up 1-3 spaces in an electrical panel.

In the first embodiment, panels supplied by a three-phase high leg delta configuration at 208/120 v can utilize this as a single-polled device on the B-phase high leg. This space typically has 208V available, making it useless for 120V loads. The device permits 120V loads on this high leg without damaging a load.

The second embodiment is used in a three-phase 480/277 V service configuration. This device can be used as a single-pole device where the 277V is established to derive 120V or as a three-poled device to establish 120V on each leg to meet any required voltage dictated by a load. It could also be used when a three-polled device converts 480V to 120V on each leg for use with loads demanding smaller amounts of voltage. This device permits all spaces within an electric panel to be used for any voltage requirement determined by any load.

To further describe the 208/120 v high leg (first embodiment), when installed in the high leg location of the B phase in a 208/120 V three-phase system, voltage first flows through the device by clipping onto the bus. The bus clip allows electrons to flow to the rectifier. The diodes within the rectifier permit the flow in only one direction, which produces DC power. From there, the flow moves toward the capacitor, which absorbs and filters out high-frequency variations. From there, DC output is more stable when it flows into the inverter, where AC power is generated. AC power is generated via pulsations over a duration. This simulation of an AC waveform at a specific pulsation rate for the desired 120 v output can then flow out of the inverter to the stationary contact.

When the device's handle is put into the on position, the latch affixed with a moving contact makes contact with the stationary contact, permitting the flow of electrons to move through the coil, electromagnet, and then to the load. The electromagnet is the safety mechanism preventing hazardous circuit current levels. In short, the device provides any desired voltage while maintaining safety.

This device is suitable for use within electrical systems and configurations in the United States and other countries. For example, in Europe, where available voltages are 220V and 230V@50 HZ, the device can be installed in the desired phase locations to lower the voltage to 120V or for any smaller load requirements.

### A Mechanism to Alter a High Voltage for a Lower Voltage Load

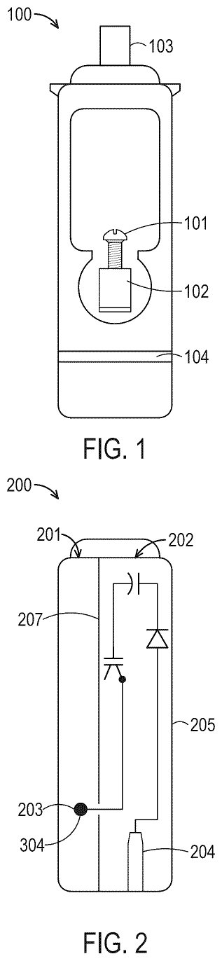

With reference to FIGS. 1 to 4, the MECHANISM TO ALTER A HIGH VOLTAGE FOR A LOWER VOLTAGE LOAD will now be described. FIG. 1 depicts (100) the device's groove and clip as well as the terminal screw and wire terminal (301). The terminal screw (101) holds the load wiring securely in place in the terminal (102). The wire terminal (301) accepts a wire from a load, allowing it to attach correctly and securely to the device. The handle (104) permits the device to be turned on or off, to sit in the tripped position, or to be tied to an adjacent device's handle. The panel clip groove (105) ensures the device is securely fastened to the electric panel. It seats over the lip preventing it from falling out or moving.

FIG. 2 depicts (200) the busbar clip and inner mechanisms of the electromagnet working in unison with the VFD. The electromagnet (201) prevents a short circuit or overload and is a protective measure for a load by utilizing electromagnetic functionality. The VFD (202) view alters the supply bus's incoming voltage to establish a desired voltage for a load. The bus clip (204) securely fastens onto the electric panel bus bar, allowing electrons to flow into the device. The casing, shell, or housing (205) encases the device and houses all parts of the device. The housing (205) is constructed of insulated material, preventing arcs and undesirable transferences of electricity to other parts of the device and providing structural integrity. The inner casing's divider (208) separates and protects the components of the electromagnet function from the VFD function while also providing additional structural integrity to the device.

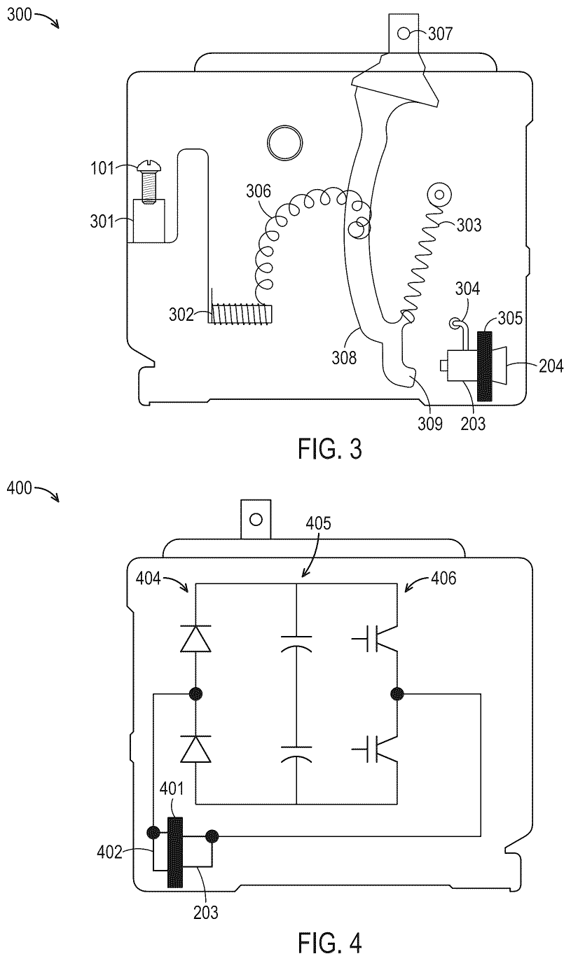

FIG. 3 depicts the construction of the electromagnet mechanism (300), which protects the load. The electromagnet (302) safeguards by preventing abnormal and undesirable levels of electricity from negatively affecting the load. The electromagnet (302) reacts to dangerously high levels of electricity; as the magnetic field increases, the electromagnet moves, pulling at the connected coil and latch. The spring (303) keeps tension on the latch (308). When the electricity exceeds acceptable levels, the electromagnet is engaged and pulls at the coil attached to the latch (308). The latch (308) is pulled back, and the tension in the spring (303) causes the contacts to separate. The metallic jumper (304) connects the inverter circuit to the stationary contact (203), permitting the flow of electrons. The separation wall (305) prevents the flow of electrons from the bus bar clip (204) to the stationary contact (203) by isolating them from each other. [306 See 204] The stationary contact (203) permits the flow of electricity to move from the inverter circuit across and through the metallic jumper (304) to the moving contact (309) affixed to the latch (308). When the latch (308) is engaged, the moving contact (309) connects with the stationary contact (203), and electrons flow toward the load. [308 (see 101) 306]. The coil (306) is fixed to the latch (308) and the electromagnet (201). When it engages, the coil (308) is pulled with the electromagnet (302), pulling the latch (308) with the affixed moving contact (309) away from the stationary contact (203). The handle tie hole (307) is intended for the use of handle ties when adjoining devices side-by-side. The latch (308) works in unison with the moving contact (309), electromagnet (302), and spring (303) by denoting the device's operation and abilities. The latch (308) has a moving contact (309) affixed to it. The moving contact (309) is fastened onto the tip of the latch (308). The moving contact (309) will release from the stationary contact (203) into the trip position when the electromagnet (302) engages, pulling the coil (306) and latch (308). If the electromagnet (302) isn't engaged, the moving contact (309) and stationary contact (203) connect, permitting the flow of electrons further into the device. In the off position, the latch (308) with moving contact (309) is separate from the stationary contact (203). Electrons flow further into the device when engaged with stationary contact (203).

FIG. 4 depicts the VFD construction and connection to the electromagnetic mechanism (400 and 401). This side regulates the output voltage. The rectifier (404) utilizes the input AC power from the bus bar clip (204). It converts it to DC power using diodes, directing the flow of electrons in only one direction, flowing to the capacitor. The capacitor (405) utilizes the DC output from the rectifier. It absorbs and filters out the DC high-frequency variations. The output energy is stored and then smoothed out for a more stable input to the inverter (406). The inverter (406) takes the DC output from the capacitor (405) and generates AC power, which flows to the stationary contact (203). The inverter uses pulsations to switch the voltage on and off for a desired duration to simulate an AC waveform. This composition rate can be used to achieve the desired output voltage to flow to the stationary contact (203).

Applicant(s) reserves the right to submit claims directed to combinations and sub-combinations of the disclosed inventions that are believed to be novel and non-obvious. Inventions embodied in other combinations and sub-combinations of features, functions, elements, and properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A mechanism to alter a high voltage for a lower voltage load comprising: providing an electrical load, an electrical breaker, and a variable frequency drive (VFD), where the electrical load is connected to the electrical breaker, the electrical breaker is connected to the VFD.

2. The mechanism of claim 1, where the electrical breaker includes a means to prevent excessive current.

3. The mechanism of claim 2, where the VFD includes a means to convert AC voltage to DC voltage, absorb and filter out high-frequency DC voltage variations, store the electricity, smooth the electricity out, convert electricity to a desired waveform, and output the electricity in the desired waveform.

4. The mechanism of claim 3, where the electrical breaker is selected from a 1, 2, 3, or 4 pole breaker.

5. The mechanism of claim 3, where the voltage is stepped down from a higher voltage to a lower voltage or a lower voltage to a higher voltage.

6. The mechanism of claim 3, where the voltage is stepped down from 208V to 120V, 480V to 120V, 277V to 120V, 230V to 120V, or 400V to 120V.
